(19) United States
(12) Patent Application Publication
(10) Pub. No.: US 2009/0265570 A1
(43) Pub. Date: Oct. 22, 2009

(54) BATTERY STRUCTURE OF PORTABLE ELECTRONIC DEVICE

(75) Inventor: Stephen Chen, Changhua (TW)

Correspondence Address: ROGER H. CHU, 19499 ERIC DRIVE, SARATOGA, CA, 95070, US

(73) Assignee: E-LEAD ELECTRONIC CO., LTD., Shengang Shiang (TW)

(21) Appl. No.: 12/107,074

(22) Filed: Apr. 22, 2008

(51) Int. Cl. G06F 1/28

(52) U.S. Cl. 713/340

(57) ABSTRACT

A battery structure of portable electronic device comprises an electronic device body, a power supply input module, an internal battery, an external battery module, and a power supply control module. The invention enables the following process priorities that the power supply control module automatically switches the power charging between the internal battery and the external battery when the external power supply input terminal electrically connects an external power supply.

### FIELD OF THE INVENTION

The present invention relates to a battery structure of portable electronic device, especially a power supply/charging structure of a portable electronic device that enables the power supply between internal battery and external battery to be automatically switched.

### BACKGROUND OF THE INVENTION

Most of portable electronic devices on the market, such as a notebook computer, a PDA, a laptop computer or a portable PC, etc., have similar problems of lacking sufficient power supply to cause power outage; if the battery of such a portable electronic device is unable to be recharged or replaced in time, data stored in the portable electronic device is possibly lost or the device is unable to be operated.

Generally, a conventional portable electronic device is either connected to an external electric power supply socket or equipped with an internal battery, therefore, in case of insufficient electric power supply or battery recharging is required, the user is able to replace a backup battery.

The aforementioned electronic device, such as a notebook computer, a PDA, a laptop computer or a portable PC, etc., is equipped with dual/quad-core CPU to perform excellent data processing, adding to the wireless communication function inside, consequently, the power consumption of such an electronic device has been considerably increased than before. If considering an increase in more internal battery(s) inside such an electronic device, such an electronic device is unable to minimize its size or its weight is possibly increased to cause inconvenience to a user. In summary, extended battery operation of a portable electronic device has become a critical subject to be improved.

Prior art of U.S. Pat. No. 6,160,378 of “Battery Charger With Detachable Mechanical Adapters And Fold-Out Connectors” utilizes detachable mechanical adapters, so that the battery charger can operate as a single battery charger or a dual battery charger. The prior art comprises detachable battery holders connecting a battery to the battery charger for recharging. The battery charger operates as an AC/DC converter to provide operating DC to a notebook computer that is coupled to the battery charger.

Another prior art of U.S. Pat. No. 5,867,007 of “Selection Circuit For Dual Batteries In A Battery Powered Electronic Device” employs dual batteries used in battery powered electronic devices, comprising a battery selection circuit, which enables the switch of a first battery and a second battery, in case of insufficient battery power. When the circuit is adopted in a notebook computer, battery usage time is substantially increased with prolong battery life.

The technologies of the aforementioned prior arts applied for patents mainly focused on external battery charging station or circuit switching designs, which are unable to meet the requirements of battery miniaturization in a portable electronic device, the power outage risk of battery switch circuit and prolonged battery power supply.

In view of the drawbacks of battery structures of prior arts, the invention discloses an improved battery structure of a portable electronic device, enabling a power supply control module to be electrically connected between an internal battery, an external battery module and a voltage stabilizing circuit, so as to automatically switch the power supply between the internal battery and the external battery of the portable electronic device. When an external power supply input terminal is electrically connected to an external power supply unit for operation, a power supply control switch is then used to switch recharging sequence between the internal battery and the external battery, therefore, the battery structure of the invention is able to achieve the battery-powered optimal and automatically switch the power supply and charging to prevent power outage possibility.

### SUMMARY OF THE INVENTION

In view of the forgoing defects of conventional techniques, a battery structure of a portable electronic device is disclosed hereafter, which enables a power supply control module, which is electrically connected between an internal battery, an external battery module and a voltage stabilizing circuit, to automatically switch the power supply between the internal battery and the external battery for the portable electronic device, in order to prevent the portable electronic device from data loss due to any power outage state.

Another objective of the invention is to provide a battery structure of portable electronic device, enabling a power supply control module to be electrically connected between the internal battery and the external battery module. When the power supply of the portable electronic device is provided externally, the internal battery installed in the device is charged with first priority; subsequently, the external battery is charged after the internal battery is full-charged. Consequently, the invention enables the external battery to be charged without additional battery charger required, at the same time, prolongs battery life and battery usage time.

Another objective of the invention is to provide a battery structure of portable electronic device comprising a power supply control module, which is an analog circuit without the time delay so as to automatically enable stable power supply for the portable electronic device, when any input voltage drop is detected by the voltage stabilizing circuit.

To achieve the aforementioned objectives, a battery structure of portable electronic device in accordance with the invention comprises:

an electronic device body;

a power supply input module, comprising an external power supply input terminal and a charging circuit; utilizing a diode, an internal battery and the external power supply input terminal to provide the electronic device with power supply, in addition to the power charging source for the internal battery;

the internal battery, which is installed in the electronic device body and is used to provide power supply to the electronic device through a circuit for switching battery power supply and the diode. The internal battery is connected to a power supply control module and the charging circuit. The characteristic of the invention lies in that the internal battery includes a battery status indicator; therefore, when there is an electric potential change after the internal battery reaches full charge, the power supply control module automatically switches power supply of the portable electronic device to the connection of external battery terminal(s);

an external battery module, providing external power supply for the electronic device and comprising at least an external battery terminal(s) connected thereto and an external battery. When the external battery becomes the major power supply for the portable electronic device, the external battery terminal(s) is connected to the diode and the internal battery, in addition, electrically connected the charging circuit through the power supply control module, consequently, the external battery provides power supply for the electronic device body in connection to the external battery terminal(s). The characteristic lies in that a battery status indicator is placed inside; in case there is a voltage change after the external battery power is exhausted or the external battery is removed from the portable electronic device, the circuit for switching battery power supply switches power supply of the portable electronic device to the connection of the internal battery;

the power supply control module, which is used to control the switches of the charging and discharging between the internal battery and the external battery, further comprising:

an external battery charging circuit and an internal battery charging circuit to connect the internal battery and serially connect the diode; in addition, control the internal battery power supply when the external battery is exhausted;

a circuit for switching battery power supply, one end of which connects the charging circuit and the other end of which connects the internal battery and the external battery terminal(s), respectively. The circuit for switching battery power supply alternatively switches on the charging circuit in connection to either the internal battery or the external battery terminal(s), in order to control the charging of the external battery.

In view of the foregoing, the invention enables the following process priorities that the power supply control module automatically switches the power charging between the internal battery and the external battery when the external power supply input terminal electrically connects an external power supply.

A detailed description is given in the following embodiments with reference to the accompanying drawings.

### BRIEF DESCRIPTION OF THE DRAWINGS

FIG. 1 is a structural view showing a conventional backup battery power socket of a notebook computer;

FIG. 2 is a structural view showing another conventional backup battery power socket of a notebook computer; and

FIG. 3 is a block diagram showing the actuation of battery structure circuits of a portable electronic device in accordance with the invention.

### DETAILED DESCRIPTION OF THE INVENTION

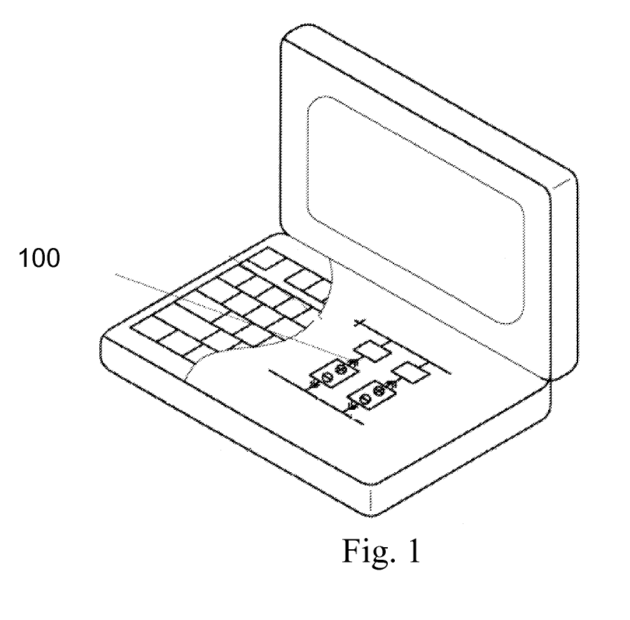

With reference to FIG. 1 showing a conventional backup battery power socket of a notebook computer, a backup battery power socket (100) that is specially provided for a backup battery is equipped on a portable notebook computer. When there is insufficient power supply for the notebook computer, the backup battery power socket (100) is then electrically connected to the backup battery for supplying electricity to the notebook computer body. However, such a power supply method easily causes power outage problem to the notebook computer. Especially, there is no any power supply control switch to automatically switch the on and off of internal or external battery for supplying electricity to the notebook computer, therefore, unexpected power outage may cause instant power-off of the notebook computer and data loss to a user.

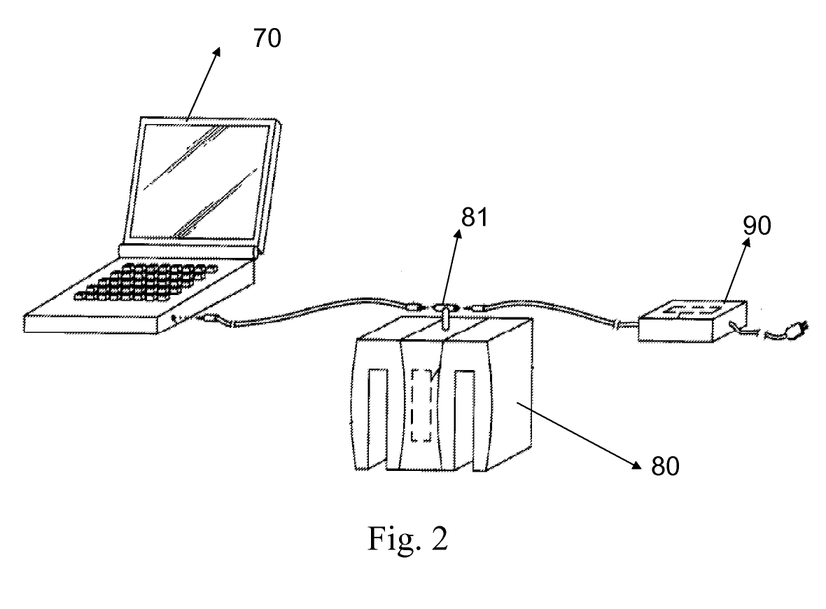

FIG. 2 shows another backup battery power socket of a notebook computer that when a notebook computer (70) is charged by external power supply, a cable is connected to a detachable battery charging station (80), which comprises a battery charging station connector (81) to connect an AC/DC converter (90) through the cable for external charging. In addition, the detachable battery charging station (80) is a battery charger for charging one single battery (only applied as a backup battery) or dual batteries (enabling a backup battery and the notebook computer to be charged at the same time). However, such conventional design is unable to perform stable battery charging, so that some problems, such as incomplete battery charging or abnormal power supply may cause to the notebook computer (70), when its battery is removed.

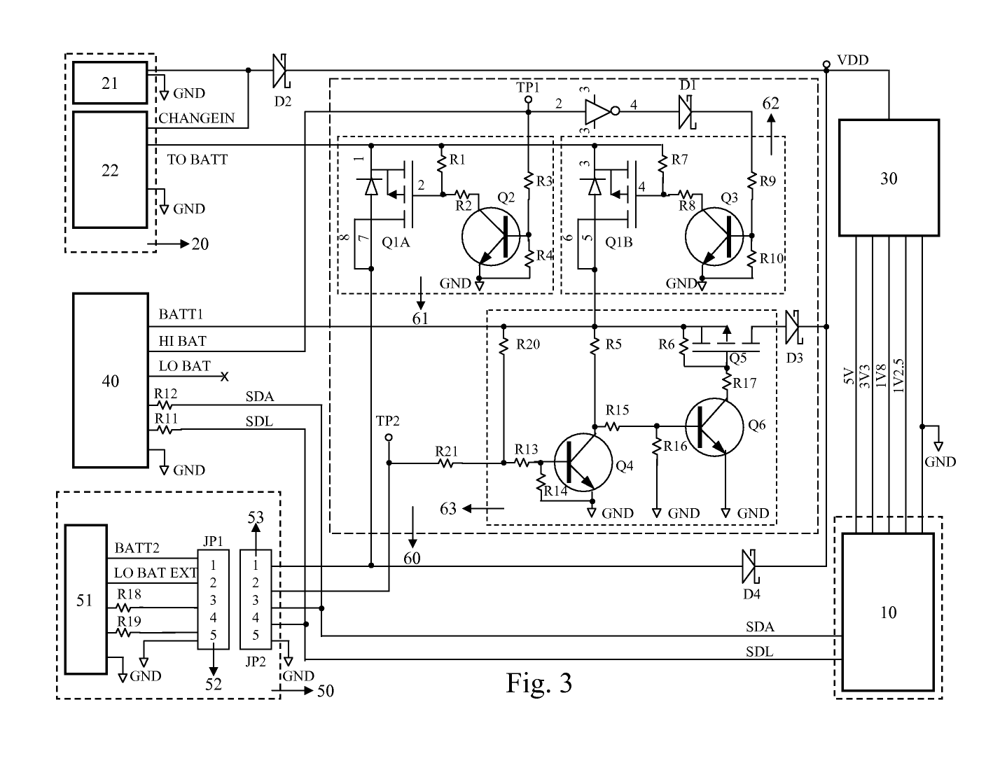

FIG. 3 shows a block diagram of a preferred embodiment in accordance with the invention that a battery structure of portable electronic device comprises an electronic device body (10), which is either a notebook computer, a portable computer, a laptop computer or a PDA, in addition, is electrically connected to a power supply input module (20). The power supply input module (20) comprises an external power supply input terminal (21) and a charging circuit (22). In addition, the power supply input module (20) is connected to an external power supply, enabling the electricity supply to the electronic device (10). Moreover, the power supply input module (20) further connects an external battery and utilizes a diode, an internal battery (40) and the external power supply input terminal (21) to enable power supply, in addition to the connection of the external battery terminal(s) providing the power source for the internal battery (40).

Moreover, a voltage stabilizing circuit (30) is electrically connected to the electronic device (10) and the power supply input module (20), in addition, internally connected to the diode, the external power supply input terminal (21) and the internal battery (40) for the purpose of stably charging the electronic device body 10.

In addition, the internal battery (40) is installed inside the electronic device body (10) and electrically connected to the voltage stabilizing circuit (30) and the charging circuit (22), providing power for the electronic device body (10) through a circuit for switching battery power supply (63) and the diode. The internal battery (40) is connected to a power supply control module (60) and charging circuit (22). The characteristic of the invention lies in that the internal battery (40) further includes a battery status indicator; therefore, when there is an electric potential change after the internal battery (40) reaches full charge, the power supply control module (60) automatically switches power supply to the connection of external battery terminals (52) and (53).

An external battery module (50) comprises at least the external battery terminals (52) and (53) to connect an external battery (51), and is electrically connected to the internal battery (40) and the voltage stabilizing circuit (30) for the power supply to the external battery of the electronic device (10), in addition, is electrically connected the charging circuit (22) through the power supply control module (60) and enables the external power supply input terminal (20) to connect the power source. The characteristic lies in that a battery status indicator is placed inside; in case there is a voltage change after the power of external battery connecting the external battery terminals (52) and (53) is exhausted or the external battery is removed, the circuit for switching battery power supply (63) switches power supply to the connection of the internal battery (40). Upon battery charging, the charging circuit (22) further comprises the power supply control module (60), which is electrically connected to the internal battery (40), the external battery module (50) and the voltage stabilizing circuit (30), so as to automatically switch the power supply between the internal battery (40) and the external battery (51) of the electronic device (10). When the external power supply input terminal (21) is electrically connected to an external charger, the power supply control module (60) is applied to automatically switch the charging priority between the internal battery (40) and the external battery (51).

The internal battery (40) further comprises a battery status indicator to show the electricity status of respective batteries for the electronic device, when there is an electric potential change after the internal battery (40) reaches full charge, a high voltage status is displayed, or a lower voltage status is displayed when the external battery is exhausted or removed from the notebook computer.

The external battery is a lithium battery, a Ni-MH battery, a lead-acid battery, a Ni—Cd battery or a fuel cell.

A power supply control module (60), which is used to control the switches of the battery charging and discharging, further comprising:

An external battery charging circuit (61) and an internal battery charging circuit (62) to connect the internal battery (40) and serially connect the diode; in addition, control the internal battery power supply based on the electricity exhaustion indication of the external battery terminals (52) and (53);

A circuit for switching battery power supply (63), one end of which connects the charging circuit (22) and the other end of which connects the internal battery (40) and the external battery terminals (52) and (53), respectively. The circuit for switching battery power supply alternatively switches on the charging circuit (22) in connection to either the internal battery (40) or the external battery terminals (52) and (53), in order to accept the full-charge signal of the internal battery (40).

In view of the foregoing, the invention enables the following process priorities that the power supply control module automatically switches the power charging between the internal battery and the external battery when the external power supply input terminal electrically connects an external power supply.

In a preferred embodiment of the invention, the power supply control module (60) is an analog circuit without the time delay and is composed of the external battery charging circuit (61), the internal battery charging circuit (62) and the circuit for switching battery power supply (63). When the power supply control module (60) is connected to a voltage input terminal of the voltage stabilizing circuit (30) and the voltage is instantly dropped to 0.7v, the power is stably supplied for the computer. When the external battery (51) is fully charged, the circuit for switching battery power supply (63) is off and the power is stably supplied to the portable electronic device. In case the device is connected to an external power supply and the electricity is cut off, the circuit for switching battery power supply (63) is then on and connected to the internal battery (40) for power supply until the external battery (51) is fully charged, and then, the circuit for switching battery power supply (63) is off and the power supply to the electronic device is switched to the external battery (51). When the device is connected to an external power supply for battery charging, the power supply control module (60) enables the internal battery charging circuit (62) to actuate the charge of the internal battery (40); after the internal battery (40) reaches full charge, the power supply control module (60) enables the external battery charging circuit (61) to actuate the charge of the external battery (51). Consequently, the power supply control module (60) enables the external battery to be charged without additional charger required, in addition, automatically switches the power supply between the internal battery (40) and the external battery (51) for the portable electronic device, so as to prevent the portable electronic device from power outage status and/or data loss.

In the preferred embodiment on the invention, a circuit is installed in chip sets of the electronic device body (10) for detecting electric usage of respective batteries for a user. Moreover, the circuit is able to electrically connect to chip sets of said electronic device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A battery structure of portable electronic device, comprising:
an electronic device body;
a power supply input module, comprising an external power supply input terminal and a charging circuit; utilizing a diode, an internal battery and an external power supply input terminal to provide said electronic device with power supply, in addition to the power charging source for said internal battery;
said internal battery, installed inside in said electronic device body and is used to provide power supply to said electronic device through a circuit for switching battery power supply and said diode; said internal battery is connected to a power supply control module and said charging circuit; the characteristic lies in that said internal battery includes a battery status indicator, when there is an electric potential change after said internal battery reaches full charge, said power supply control module automatically switches power supply source to the connection of external battery terminal(s); and
an external battery module, providing external power supply for said electronic device, and comprising at least an external battery terminal(s) connected to an external battery; when the external battery becomes the major power supply for said electronic device, said external battery terminal(s) is connected to said diode and said internal battery, in addition, electrically connected said charging circuit through said power supply control module; the characteristic lies in that a battery status indicator is placed inside; in case there is a voltage change after the energy of said external battery is exhausted or said external battery is removed from said portable electronic device, said circuit for switching battery power supply switches power supply of said portable electronic device to the connection of said internal battery;
wherein, a power supply control module, which is used to control the switches of the charging and discharging between said internal battery and said external battery, further comprising:
an external battery charging circuit and an internal battery charging circuit to connect said internal battery and serially connect said diode; in addition, control the power supply of said internal battery when the external battery is exhausted;
a circuit for switching battery power supply, one end of which connects said charging circuit and the other end of which connects said internal battery and said external battery terminal(s), respectively; said circuit for switching battery power supply alternatively switches on said charging circuit in connection to either said internal battery or said external battery terminal(s), in order to control the charging of the external battery;
in view of the foregoing, the following process priorities enables said power supply control module automatically switches the power charging between said internal battery and said external battery when the external power supply input terminal electrically connects an external power supply.

2. The battery structure of portable electronic device as claimed in claim 1, wherein said external battery module utilizes said external terminal to connect said external battery.

3. The battery structure of portable electronic device as claimed in claim 1, wherein said power supply control module is an analog circuit without the time delay.

4. The battery structure of portable electronic device as claimed in claim 1, wherein said internal battery further comprises a battery status indicator to display electric usage of respective batteries of said electronic device.

5. The battery structure of portable electronic device as claimed in claim 4, wherein said battery status indicator is used to display a high voltage status, after said internal battery reaches full charge.

6. The battery structure of portable electronic device as claimed in claim 4, wherein said battery status indicator is used to display a lower voltage status, when said external battery is exhausted or removed from a portable electronic device.

7. The battery structure of portable electronic device as claimed in claim 1, wherein said external battery is a lithium battery, a Ni-MH battery, a lead-acid battery, a Ni—Cd battery or a fuel cell.

8. The battery structure of portable electronic device as claimed in claim 1, wherein said electronic device is a notebook computer, a portable computer, a laptop computer or a PDA.

9. The battery structure of portable electronic device as claimed in claim 1 further comprises a voltage stabilizing circuit, which is connected to said electronic device body and said power supply input module for control stable power supply source to said electronic device body.

10. The battery structure of portable electronic device as claimed in claim 1 further comprises a circuit is installed in chip sets of said electronic device body for detecting electric usage of respective batteries for a user.

11. The battery structure of portable electronic device as claimed in claim 10, wherein said circuit is electrically connected to chip sets of said electronic device.
